(19) United States
(12) Patent Application Publication
(10) Pub. No.: US 2015/0032401 A1
(43) Pub. Date: Jan. 29, 2015

(54) device and method for geometrically calibrating sensor data generated with the aid of a sensor system of a vehicle

(71) Applicant: Stefan Nordbruch, Kornwestheim (DE)

(72) Inventor: Stefan Nordbruch, Kornwestheim (DE)

(21) Appl. No.: 14/349,553

(22) PCT Filed: Aug. 6, 2012
(86) PCT No.: PCT/EP2012/065338

§ 371 Date: Aug. 26, 2014

(30) Foreign Application Priority Data
Oct. 4, 2011 (DE) 102011083965.8

(51) Int. Cl. G01D 18/00

(52) U.S. Cl. CPC G01D 18/00
USPC 702/104

(57) ABSTRACT

A device for geometrically calibrating sensor data which are generated with a sensor system of a vehicle and which correspond to the vehicle surroundings, including: an ascertainer for ascertaining a geometric variable in sensor units of a physical object of the vehicle surroundings based on the sensor data, a retriever for retrieving the geometric variable in real physical units of the physical object from a database in which geometric variables in real physical units of the physical object, which are assigned to a path, are stored, and a computer for computing a conversion factor for converting sensor units into real physical units based on the ascertained geometric variable in sensor units and on the retrieved geometric variable in real physical units. Also described is a corresponding method as well as a corresponding system and a corresponding computer program.

### FIELD OF THE INVENTION

The present invention relates to a device and a method for geometrically calibrating sensor data generated with the aid of a sensor system of a vehicle. The present invention also relates to a system for geometrically calibrating sensor data generated with the aid of a sensor system of a vehicle. The present invention furthermore relates to a computer program.

### BACKGROUND INFORMATION

Driver assistance systems of a vehicle generally use surroundings sensor systems, with the aid of which the vehicle surroundings may be sensorially detected. The driver assistance systems are then usually operated based on the detected vehicle surroundings. For a proper operation of the driver assistance systems, the information regarding which sensor path corresponds to the path in the real world is generally needed. This therefore means in particular that the information is needed as to how many centimeters in the real world correspond to a pixel in an image which was recorded with the aid of the surroundings sensor systems.

This information is generally estimated on the basis of several assumptions. It is believed to be understood, for example, that the lane is searched in an image recorded with the aid of a surroundings sensor system. It is subsequently assumed that the lane has a standard width and the centimeter/pixel ratio is ascertained from the detected lane using the standard assumption.

It is believed to be particularly disadvantageous that this estimation may be very prone to errors, since it is based on assumptions. For example, the lane could be a lot more narrow or wider at one point than the standard width. Thus, a basic piece of information regarding the operation of all functions which are provided by the driver assistance system would be wrong. This therefore means in particular that the functions may produce erroneous results.

### SUMMARY OF THE INVENTION

An object underlying the present invention may therefore be seen as providing a device for geometrically calibrating sensor data which are generated with the aid of a sensor system of a vehicle, which correspond to the vehicle surroundings, and using which a more reliable operation of a driver assistance system of a vehicle is possible.

The object underlying the present invention may also be seen as providing a corresponding method as well as a corresponding system.

The object of the present invention may also be seen as providing a corresponding computer program.

These objects are achieved with the aid of the particular subject matter of the independent claims. Advantageous embodiments are the subject matter of their respective dependent subclaims.

According to one aspect, a device is provided for geometrically calibrating sensor data generated with the aid of a sensor system of a vehicle, the sensor data corresponding to the vehicle surroundings. This therefore means in particular that the sensor system sensorially detects the vehicle surroundings and generates corresponding sensor data.

The device includes an ascertainer for ascertaining a geometric variable in sensor units of a physical object of the vehicle surroundings based on the sensor data. The device furthermore includes a retriever for retrieving the geometric variable in real physical units of the physical object in a database. In this database, geometric variables are stored in real physical units of physical objects which are assigned to a path. Furthermore, a computer is provided for computing a conversion factor for converting sensor units into real physical units based on the ascertained geometric variable in sensor units and on the retrieved geometric variable in real physical units.

According to another aspect, a method is provided for geometrically calibrating sensor data generated with the aid of a sensor system of a vehicle, the sensor data corresponding to the vehicle surroundings. A geometric variable in sensor units of a physical object of the vehicle surroundings is ascertained, the ascertainment being based on the sensor data. Furthermore, the geometric variable in real physical units of the physical object is retrieved from a database in which geometric variables in real physical units of physical objects, which are assigned to a path, are stored. Subsequently, a conversion factor is computed, with the aid of which sensor units may be converted into real physical units. The computation of the conversion factor is carried out based on the ascertained geometric variable into sensor units and the retrieved geometric variable into real physical units.

According to yet another aspect, a system is provided for geometrically calibrating sensor data which are generated with the aid of a sensor system of a vehicle and which correspond to the vehicle surroundings. The system includes a device for geometrically calibrating sensor data which are generated with the aid of a sensor system of a vehicle and which correspond to the vehicle surroundings. Furthermore, the system includes a database in which geometric variables in real physical units of physical objects, which are assigned to a path, are stored.

According to yet another aspect, a computer program is provided which includes program code for carrying out the method for geometrically calibrating sensor data which are generated with the aid of a sensor system of a vehicle and which correspond to the vehicle surroundings, when the computer program is executed on a computer.

The present invention thus includes the idea, in particular, of recognizing a physical object of the vehicle surroundings from the sensor data which are generated with the aid of a sensor system of a vehicle and of ascertaining a geometric variable of the physical object. Here, the geometric variable is indicated in sensor units, since the underlying data are sensor data. For example, the geometric variable may be a certain number of pixels.

The geometric variable of the previously recognized physical object is then retrieved from a database, only the geometric variable being indicated here in real physical units. This therefore means in particular that a relevant request is posed to the database in order to receive information regarding the value of the geometric variable in real physical units. For example, the database may in this case provide the information that the geometric variable is several meters in real physical units.

Based on the ascertained geometric variable in sensor units and based on the retrieved geometric variable in real physical units, a conversion factor is computed with the aid of which sensor units may be advantageously converted into real physical units. If, for example, the geometric variable in sensor units is two pixels and it is furthermore known that the geometric variable in real physical units is two meters, it may be computed that one pixel in sensor units corresponds to one meter in real units. The corresponding conversion factor would be 2 in this case.

Due to the fact that for the computation of the conversion factor the real geometric variable of the physical object is used, the conversion factor may be exactly computed. In the related art, however, assumptions, which may be erroneous, i.e., in particular, not correspond exactly to the real world, were used for the computation of the conversion factor. A conversion factor computed according to the related art does therefore not correspond to the reality.

It is now advantageously made possible with the aid of the conversion factor to geometrically calibrate the sensor data. Since these sensor data may be provided to a driver assistance system, such a driver assistance system may be reliably operated, since the sensor data were calibrated in a geometrically correct manner. The driver assistance system is thus advantageously provided with the knowledge as to which geometric variables correspond to the sensorially detected physical objects of the vehicle surroundings. This information is relevant in particular when the driver assistance system must make a decision, for example, as to whether the vehicle is still within a lane or how far away the vehicle is from a sensorially recognized physical object.

A geometrical calibration in the sense of the present invention means in particular that the physical objects, which correspond to the sensor data, are correlated geometrically correctly in relation to one another. This therefore means in particular that an ascertainment or determination of geometric variables of other physical objects, which were sensorially detected with the aid of the sensor system, may be carried out from the geometrically calibrated sensor data. In particular, a distance may be ascertained between the individual physical objects. It is in particular also possible that the ground of the vehicle surroundings is recognized correctly from the geometrically calibrated sensor data. The other physical objects are then correlated to the ground in particular. In this way, road markings may, for example, be correctly positioned at the level of the ground. In the case of an assumption according to the related art, it may occur that the road markings are positioned above the ground.

According to one specific embodiment, a sensor system is provided which may sensorially detect the vehicle surroundings and in particular generate corresponding sensor data. Such a sensor system may, for example, include a video sensor, in particular a stereo-video sensor. A sensor system may include a 3D camera. According to another specific embodiment, it may be provided that the sensor system may include a 360° camera which is also referred to as a surround camera. The sensor system may, for example, also include a lidar and/or a radar and/or an ultrasonic sensor. The sensor system may include a time-of-flight (TOF) sensor. Such a sensor may in particular be used for a distance measurement with the aid of a time-of-flight method. In particular, the surroundings sensor system may also include a photonic mixing device (PMD) sensor. Since the sensor system in particular sensorially detects vehicle surroundings, it may, for example, also be referred to as a surroundings sensor system.

According to one specific embodiment, the physical object may be a road, a roadway, or a curve. The geometric variable may then be in particular a width of the road or the roadway or a curve radius. A physical object may, in particular, also be a traffic sign or a boundary post of the roadway. A physical object may, for example, also be a road marking. A geometric variable of a physical object may, for example, be a length, a height and/or a width of the physical object. A geometric variable may also be an angle, for example. A geometric variable may also be a distance of the physical object from another physical object.

In one specific embodiment, multiple physical objects may also be recognized from the sensor data, the corresponding geometric variable being ascertained in sensor units in each case. Data is retrieved from the database in a similar manner. Subsequently, a corresponding conversion factor may be computed for each of the recognized physical objects. In this way, an averaged conversion factor, with the aid of which a geometric calibration of the sensor data is then possible as a whole, may be particularly advantageously computed from these several conversion factors.

According to one specific embodiment, a position determination device is provided with the aid of which a vehicle position may be determined. Such a position determination device may include a global positioning system (GPS) sensor. The position determination device may be configured as a navigation system. The position determination device may be configured to assign to the sensor data a vehicle position at the point in time of the generation of the sensor data. This therefore means in particular that a vehicle position is determined at the point in time of the generation of the sensor data, and this vehicle position is in particular assigned to the corresponding sensor data. Thus, knowledge is advantageously gained as to where the individual physical objects are exactly located. In particular, such a position determination may be carried out in relation to a digital map of a navigation system. This therefore means in particular that the position of the physical objects is determined in relation to a path on which the vehicle is traveling.

It may be provided that the vehicle position is transmitted to the database, so that the physical object detected with the aid of the sensor system may be assigned to the object reference data stored in the database as a function of the vehicle position. In general, physical objects of the path, which have a corresponding path position, correspond to the object reference data. This therefore means in particular that the path position of the sensorially recognized physical objects is transmitted to the database in order to select the object reference data, which correspond to the sensorially recognized physical object, from the object reference data stored in the database.

According to one specific embodiment, the database may include vehicle surroundings reference data. This therefore means in particular that such vehicle surroundings reference data are stored in the database. Such vehicle surroundings reference data in particular include the aforementioned object reference data. Vehicle surroundings reference data in the sense of the present invention include, in particular, information regarding the vehicle surroundings at a particular path position. Here, the vehicle surroundings reference data correspond to the reference vehicle surroundings. Such data may, for example, be obtained by one or multiple vehicles traveling the path and sensorially detecting the corresponding vehicle surroundings along the path. A manual correction or check may subsequently also be provided, so that the data may subsequently be used as reference. The object reference data include in particular information regarding the path with respect to the individual physical objects. Information may then be stored in the database relating to, for example, the road width, the roadway width, the curve radiuses, and the ramps. Furthermore, information relating to the stationary physical objects such as a position and the dimensions of the individual objects may be stored. Additional information may, for example, be additionally stored in the database, such as information regarding a roadway condition, e.g., whether the road is made of concrete or asphalt, and/or regarding roadway damage, e.g., whether the road has holes, and/or regarding present occurrences, e.g., a construction site resulting in changed road properties or road profiles and/or. Furthermore, lane data such as lane line colors may also be stored in the database.

According to another specific embodiment, the computer is furthermore configured to compute a plausibility conversion factor based on the ascertained geometric variable in sensor units and a theoretical geometric standard variable in real physical units of the physical object and to compare this conversion factor with the computed conversion factor for a plausibility check. This therefore means in particular that a plausibility conversion factor is computed based on the ascertained geometric variable in sensor units and a theoretical geometric standard variable in real physical units of the physical object and this conversion factor is compared with the computed conversion factor for a plausibility check. This therefore means in particular that a conversion factor is computed for converting sensor units into real physical units based on the ascertained geometric variable in sensor units and on the theoretical geometric standard variable. This conversion factor then corresponds to the plausibility conversion factor. In this way, such a standard variable may be the width of a standard road, for example. It is therefore in particular assumed that the recognized physical object is a standard road which has a corresponding standard width. The corresponding conversion factors should generally not significantly deviate from one another. In the case of a deviation which is above a predetermined value, it may be provided that the computation is repeated or other physical objects are used to compute a conversion factor.

According to one specific embodiment, a driver assistance system is provided which provides a driver assistance function. Multiple driver assistance systems may also be provided. The driver assistance systems may be formed identically or differently, in particular. Such a driver assistance system may, for example, be a lane keeping system, which may also be referred to as lane keeping support (LKS). The driver assistance system may, for example, also be an adaptive cruise control (ACC) system. The surroundings sensor system then in particular makes available the sensor data, which may be the calibrated sensor data, to the driver assistance system, so that this driver assistance system may then decide, in particular based on these sensor data, whether it makes available a corresponding driver assistance function.

According to another specific embodiment, the method may also be applied to merged sensor data. This therefore means in particular that merged sensor data may be geometrically calibrated with the aid of the method. Merged sensor data include in particular data from multiple sensors, these data being in particular averaged. For example, merged sensor data may, for example, include camera and radar data.

The present invention is described in greater detail in the following on the basis of the exemplary embodiments with reference to the drawings. The same reference numerals are used below for the same features.

### BRIEF DESCRIPTION OF THE DRAWINGS

FIG. 1 shows a device for geometrically calibrating sensor data which are generated with the aid of a sensor system of a vehicle and which correspond to the vehicle surroundings.

FIG. 2 shows a flow chart of a method for geometrically calibrating sensor data which are generated with the aid of a sensor system of a vehicle and which correspond to the vehicle surroundings.

FIG. 3 shows a system for geometrically calibrating sensor data which are generated with the aid of a sensor system of a vehicle and which correspond to the vehicle surroundings.

FIG. 4 shows a vehicle including a device for geometrically calibrating sensor data which are generated with the aid of a sensor system of the vehicle and which correspond to the vehicle surroundings.

### DETAILED DESCRIPTION

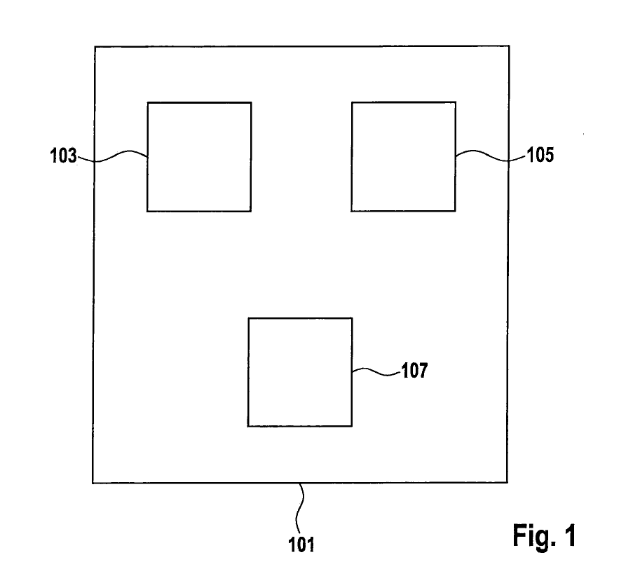

FIG. 1 shows a device 101 for geometrically calibrating sensor data which are generated with the aid of a sensor system of a vehicle and which correspond to the vehicle surroundings. Device 101 includes an ascertainer 103 for ascertaining a geometric variable in sensor units of a physical object of the vehicle surroundings based on the sensor data.

Furthermore, device 101 includes a retriever 105 for retrieving the geometric variable in real physical units of the physical object from a database in which geometric variables in real physical units of physical objects, which are assigned to a path, are stored. Furthermore, device 101 includes a computer 107 for computing a conversion factor for converting sensor units into real physical units based on the ascertained variable in sensor units and on the retrieved geometric variable in real physical units.

It is therefore advantageously made possible to carry out a precise ascertainment of the conversion factor sensor to world and vice versa, also referred to as a transformation factor, and a base height computation as the basis for driver assistance systems and in particular for systems for autonomous driving.

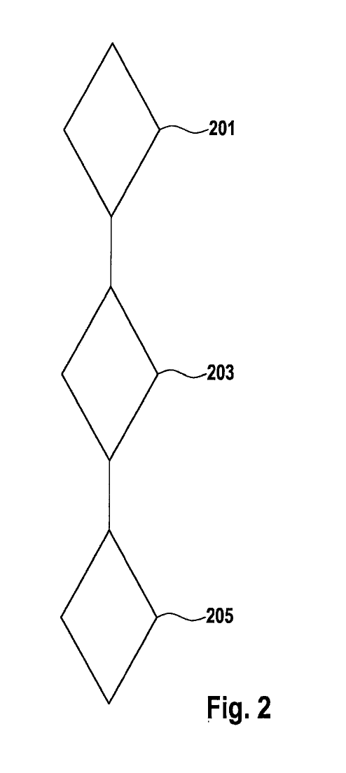

FIG. 2 shows a flow chart of a method for geometrically calibrating sensor data which are generated with the aid of a sensor system of a vehicle and which correspond to the vehicle surroundings. In a step 201, a geometric variable is ascertained in sensor units of a physical object of the vehicle surroundings based on the sensor data. Such a geometric variable in sensor units may, for example, be a number of pixels.

According to a step 203, the geometric variable in real physical units of the physical object is retrieved from a database, geometric variables in real physical units of physical objects, which are assigned to a path, being stored in the database.

According to a step 205, a conversion factor is computed with the aid of which sensor units may be converted into real physical units. This therefore means in particular that a pixel number may, for example, be converted into meters with respect to the real world. The computation of the conversion factor is based on the ascertained geometric variable into sensor units and the retrieved geometric variable into real physical units.

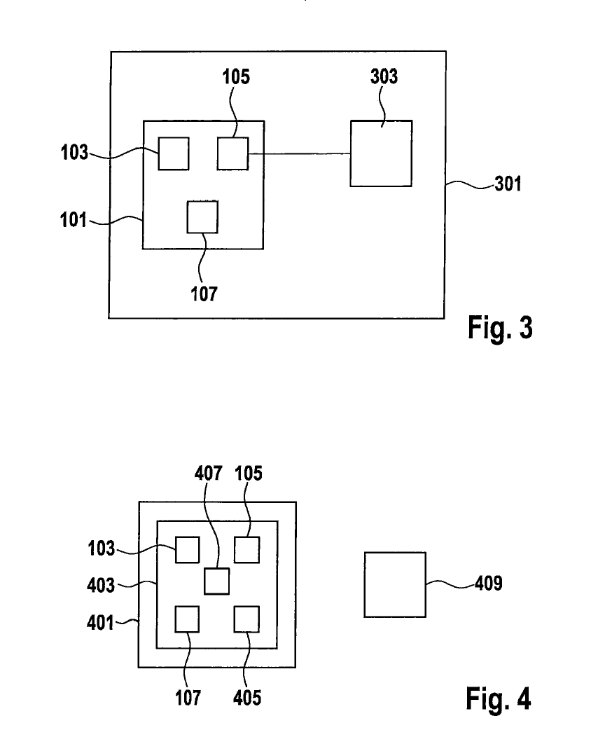

FIG. 3 shows a system 301 for geometrically calibrating sensor data which are generated with the aid of a sensor system of a vehicle and which correspond to the vehicle surroundings. System 301 includes device 101 according to FIG. 1 as well as a database 303 in which geometric variables in real physical units of physical objects which are assigned to a path are stored. In the specific embodiment shown in FIG. 3, the database is situated externally from device 101. This therefore means in particular that database 303 is situated outside of device 101. Such a database 303 may also be referred to as an external database. A communication between device 101 and database 303 may then be carried out in particular with the aid of wireless communication processes. Such a wireless communication process may, for example, be a mobile radio communication process, e.g., Long Term Evolution (LTE). This may also be a WLAN communication process, for example. This may also be a C2I communication process, for example. The abbreviation C2I stands in this case for “car to infrastructure.” A C2I communication process therefore refers to a communication process between a vehicle and an infrastructure or a physical object which is not a vehicle, e.g., a signal installation or a base station.

In the case of such a transmission, it may be provided that the corresponding communication interface is fixedly situated in the vehicle, e.g., in a central control unit. For example, the transmission may also be carried out with the aid of an external device such as a mobile phone, in particular a smart phone. This device may then, for example, in turn communicate with the vehicle, in particular with the aid of a Bluetooth communication process.

In one specific embodiment, not shown, it may be provided that database 303 is integrated into device 101. This therefore means in particular that database 303 may be situated internally in a vehicle. Here, it may then be provided in particular that a driver inputs the necessary reference data into database 303 via a data carrier. The driver may, for example, receive the corresponding reference data from an external database server via a computer.

In one specific embodiment, not shown, it may also be provided that the computation of the conversion factor is carried out externally from the vehicle. Here too, a corresponding communication may be carried out with the aid of the aforementioned communication processes. For example, a combination of an internal computation, i.e., a computation in device 101 itself, and an external computation may be provided.

FIG. 4 shows a vehicle 401 including a device 403 for geometrically calibrating sensor data which are generated with the aid of a sensor system 405 of vehicle 401 and which correspond to the vehicle surroundings. Device 403 has an essentially similar design to that of device 101 according to FIG. 1. In addition, device 403 also includes sensor system 405 and a position determination device 407. Vehicle surroundings may be sensorially detected with the aid of sensor system 405. Such a sensor system 405 may therefore also be referred to in general as a surroundings sensor system. Position determination device 407 makes it possible to determine a vehicle position. Furthermore, position determination device 407 is also configured to assign to the sensor data, which are generated with the aid of sensor system 405, a corresponding vehicle position at the point in time of the detection of the vehicle surroundings. The sensor data may in general be made available in particular to a driver assistance system (not shown here) which may be operated as a function thereof. This therefore means in particular that the driver assistance system may control a drive system, a braking system and/or a steering system of the vehicle as a function of the sensor data.

Furthermore, a database 409 is provided in which in particular geometric variables in real physical units of physical objects which are assigned to a path are stored. Other exact data of the path, e.g., a road width, a roadway width, curve radiuses and/or ramps, and/or exact data of stationary objects, e.g., position and/or dimensions, may be stored in database 409.

Other data which are stored in database 409 include, for example, a roadway condition, roadway damage, present occurrences and/or lane data. Database 409 is situated here in FIG. 4 outside of vehicle 401. Such a database 409 may therefore also be referred to as an external database. In one exemplary embodiment, which is not illustrated, it may be provided that database 409 is situated internally in vehicle 401.

According to a specific embodiment, not shown, it may be provided that the vehicle position and in particular the driving direction of the vehicle may be determined. The reference data of the real world for this vehicle position, in particular for the real world ahead of the vehicle and the driving direction, are then retrieved from database 409. Furthermore, certain physical objects, such as a roadway and/or a lane, are recognized in the sensor data and a corresponding geometric variable, such as a roadway width or a lane width, is ascertained from the sensor data. The geometric variables ascertained here are then indicated in sensor units, e.g., in pixels, for one distance level or multiple distance levels.

The geometric variable of the corresponding physical objects may then in particular be ascertained in real physical units from the retrieved reference data of the real world. The conversion factor sensor-world and, vice versa, world-sensor, and in particular the data for the base computation, may then be computed based on the geometric variable in real physical units and in sensor units. This computation may also be checked for plausibility with the aid of assumptions, e.g., based on a standard road which has a certain width in meters. It may then be provided here that the computations are repeated, if necessary.

The corresponding computations may take place continuously in this case. It may also be provided that the computations are carried out only at certain points in time, in particular at points in time at which the system is not working to capacity. This therefore means in particular that a capacity-state value is below a predetermined value.

1-10. (canceled)

11. A system for geometrically calibrating sensor data, which are generated with a sensor system of a vehicle and which correspond to the vehicle surroundings, comprising:
an ascertainer to ascertain a geometric variable in sensor units of a physical object of the vehicle surroundings based on the sensor data;
a retriever to retrieve the geometric variable in real physical units of the physical object from a database in which geometric variables in real physical units of physical objects, which are assigned to a path, are stored; and
a computer to compute a conversion factor for converting sensor units into real physical units based on the ascertained geometric variable in sensor units and on the retrieved geometric variable in real physical units.

12. The device of claim 11, further comprising:
a position determination device to determine a vehicle position which is configured to assign to the sensor data a vehicle position at the point in time of the generation of the sensor data;
wherein the retriever is configured to transmit the vehicle position to the database.

13. The device of claim 11, wherein the computer is configured to compute a plausibility conversion factor based on the ascertained geometric variable in sensor units and a theoretical geometric standard variable in real physical units of the physical object and to compare this conversion factor with the computed conversion factor for a plausibility check.

14. The device of claim 11, wherein the physical object is a road, a roadway, or a curve and the geometric variable is a width of the road or the roadway or a curve radius.

15. A method for geometrically calibrating sensor data which are generated with a sensor system of a vehicle and which correspond to the vehicle surroundings, the method comprising:
ascertaining a geometric variable in sensor units of a physical object of the vehicle surroundings based on the sensor data;
retrieving the geometric variable in real physical units of the physical object from a database in which geometric variables in real physical units of physical objects, which are assigned to a path, are stored; and
computing a conversion factor for converting sensor units into real physical units based on the ascertained geometric variable in sensor units and on the retrieved geometric variable in real physical units.

16. The method of claim 15, wherein the database includes object reference data which are assigned to a path position and which correspond to the physical object of the path, a vehicle position at the point in time of the generation of the sensor data is determined, and the request includes a transmission of the vehicle position to the database in order to assign physical objects detected with the sensor system to the object reference data stored in the database as a function of the vehicle position.

17. The method of claim 15, wherein a plausibility conversion factor is determined based on the ascertained geometric variable in sensor units and a theoretical geometric standard variable in real physical units of the physical object and this conversion factor is compared with the computed conversion factor for a plausibility check.

18. The method of claim 15, wherein the physical object is a road, a roadway, or a curve, and wherein the geometric variable is a width of the road or the roadway or a curve radius.

19. A system for geometrically calibrating sensor data, which are generated with a sensor system of a vehicle and which correspond to the vehicle surroundings, comprising:
a database in which geometric variables are stored in real physical units of physical objects assigned to a path; and
a device for geometrically calibrating the sensor data, including:
an ascertainer to ascertain a geometric variable in sensor units of a physical object of the vehicle surroundings based on the sensor data;
a retriever to retrieve the geometric variable in real physical units of the physical object from the database in which the geometric variables in real physical units of the physical objects, which are assigned to the path, are stored; and
a computer to compute a conversion factor for converting sensor units into real physical units based on the ascertained geometric variable in sensor units and on the retrieved geometric variable in real physical units.

20. A computer readable medium having a computer program, which is executable by a processor, comprising:
a program code arrangement having program code for geometrically calibrating sensor data which are generated with a sensor system of a vehicle and which correspond to the vehicle surroundings, by performing the following:
ascertaining a geometric variable in sensor units of a physical object of the vehicle surroundings based on the sensor data;
retrieving the geometric variable in real physical units of the physical object from a database in which geometric variables in real physical units of physical objects, which are assigned to a path, are stored; and
computing a conversion factor for converting sensor units into real physical units based on the ascertained geometric variable in sensor units and on the retrieved geometric variable in real physical units.
